(19) United States
(12) Patent Application Publication
(10) Pub. No.: US 2026/0284905 A1
(43) Pub. Date: Sep. 24, 2026

(54) ELECTRONIC DEVICE

(71) Applicant: Advanced Semiconductor Engineering, Inc., Kaohsiung (TW)

(72) Inventor: Tseng Yu HUANG, Kaohsiung (TW)

(73) Assignee: Advanced Semiconductor Engineering, Inc., Kaohsiung (TW)

(21) Appl. No.: 19/086,085

(22) Filed: Mar. 20, 2025

(51) Int. Cl. B25J 15/00; B25J 13/08; B25J 15/08

(52) U.S. Cl. CPC B25J 15/0009; B25J 13/089; B25J 15/08

(57) ABSTRACT

The present disclosure provides an electronic device. The electronic device includes a sensor and a bionic structure. The sensor is configured to detect an object and to generate a sensing signal. The bionic structure includes a plurality of contact surfaces. The bionic structure is configured to select one of the plurality of contact surfaces to contact the object in response to the sensing signal from the sensor.

### BACKGROUND

### 1. Technical Field

The present disclosure relates to an electronic device.

### 2. Description of the Related Art

Robotics is experiencing rapid development, with humanoid robots being particularly popular. The present robots primarily rely on computer control to perform specific actions. However, with technology evolving, robots need to possess a high level of perception and cognitive abilities to operate and interact within complex environments. For example, a robot is required to be able to sense how much force to apply when picking up an object (such as an egg) to avoid using too much force, which could damage the object, or too little force, which could result in failing to pick it up successfully. Therefore, an improved electronic device for robotic arm with sensors is called for.

### SUMMARY

In some arrangements, an electronic device includes a sensor and a bionic structure. The sensor is configured to detect an object and to generate a sensing signal. The bionic structure includes a plurality of contact surfaces. The bionic structure is configured to select one of the plurality of contact surfaces to contact the object in response to the sensing signal from the sensor.

In some arrangements, an electronic device includes a bionic structure and a first sensor. The bionic structure includes a plurality of regions configure to operate with different functions. The first sensor is configured to identify characteristics of an object. The plurality of regions are selectable to contact the object based on the characteristics of the object.

In some arrangements, an electronic device includes a first phalange region and a second phalange region separated from the first phalange region. The first phalange region includes a plurality of sensing modules and a first plurality of portions detachable from the sensing modules, respectively.

### BRIEF DESCRIPTION OF THE DRAWINGS

Aspects of some arrangements of the present disclosure are best understood from the following detailed description when read with the accompanying figures. It should be noted that various structures may not be drawn to scale, and dimensions of the various structures may be arbitrarily increased or reduced for clarity of discussion.

FIG. 1 illustrates a perspective view of an electronic device, in accordance with some arrangements of the present disclosure.

FIG. 2A illustrates a perspective view of an electronic device, in accordance with some arrangements of the present disclosure.

FIG. 2B illustrates a cross-sectional view of a bionic finger, in accordance with some arrangements of the present disclosure.

FIG. 3 is a partial enlarged view of the electronic device as shown in FIG. 2B, in accordance with some arrangements of the present disclosure.

FIG. 4 is a flowchart illustrating the method of operations of an electronic device, in accordance with some arrangements of the present disclosure.

FIG. 5A, FIG. 5B, and FIG. 5C illustrate stages of an example of operations of an electronic device according to some embodiments of the present disclosure.

### DETAILED DESCRIPTION

The following disclosure provides many different arrangements, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include arrangements in which the first and second features are formed or disposed in direct contact, and may also include arrangements in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various arrangements and/or configurations discussed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of arrangements of this disclosure are not deviated from by such arrangement.

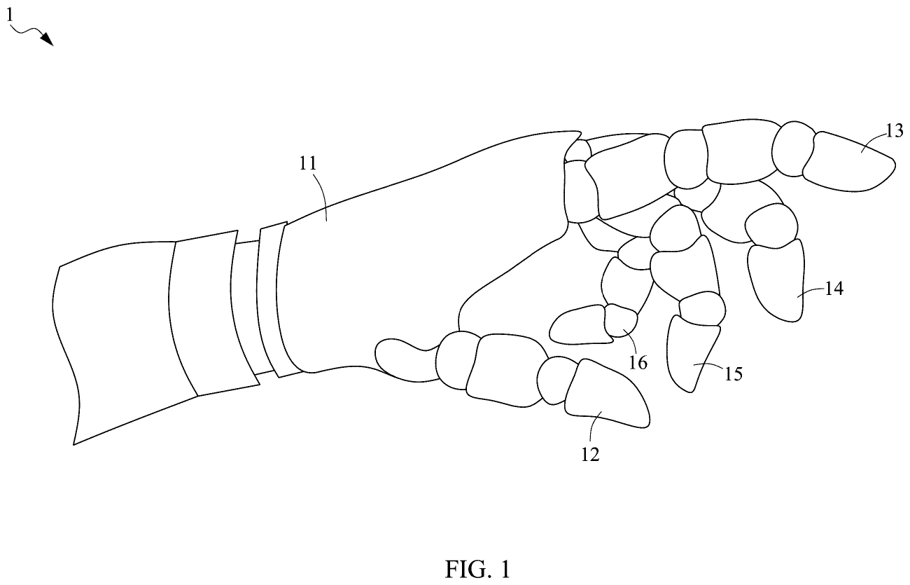

FIG. 1 illustrates a perspective view of an electronic device 1, in accordance with some arrangements of the present disclosure. In some arrangements, the electronic device 1 may be included in a robot, particularly a humanoid robot. For clarity, FIG. 1 merely shows a part of the electronic device 1, in particular the palm, thumb, and fingers. In some arrangements, the electronic device 1 may be configured to contact, hold, or grab an object (or external object). In some arrangements, when the electronic device 1 contacts, holds, or grabs an object, the electronic device 1 may be configured to generate and/or transmit a sensing signal in accordance with the stress imposed on the thumb and/or fingers. In some arrangements, the electronic device 1 may be configured to generate and/or transmit a control signal, in response to the sensing signal, to control, adjust, and/or modify the relative positions (or relative motions) among the thumb, fingers and/or objects, thereby regulating the stress applied to the electronic device 1. Consequently, this functionality may help to minimize degradation or damage to the electronic device 1.

In some arrangements, the electronic device 1 may include a palm unit 11 and mechanical units 12, 13, 14, 15, and 16. Each of the mechanical units 12, 13, 14, 15, and 16 may be mechanically coupled to the palm unit 11 independently. In some arrangements, each of the mechanical units 12, 13, 14, 15, and 16 may be rotated along the X-direction, Y-direction, and/or Z-direction independently. In some arrangements, the mechanical unit 12 (or mechanical thumb) may be configured to mimic an abduction movement of a human thumb. In some arrangements, the mechanical unit 13 (or mechanical finger) may be configured to mimic an abduction movement of a human index finger. In some arrangements, the mechanical unit 14 (or mechanical finger) may be configured to mimic an abduction movement of a human middle finger. In some arrangements, the mechanical unit 15 (or mechanical finger) may be configured to mimic an abduction movement of a human ring finger. In some arrangements, the mechanical unit 16 (or mechanical finger) may be configured to mimic an abduction movement of a human little finger. In some arrangements, the electronic device 1 may include curl joints (not denoted) coupled between the palm unit 11 and mechanical unit 12 (or mechanical unit 13, 14, 15, or 16). The curl joints may pivotally couple to the mechanical units 12, 13, 14, 15, and 16. In some arrangements, the electronic device 1 may include processors and controllers that are electrically coupled to the palm unit 11 and to the mechanical units 12, 13, 14, 15, and 16, thereby controlling, adjusting, and/or modifying the relative positions (or relative motions) among the palm unit 11 and mechanical units 12, 13, 14, 15, and 16.

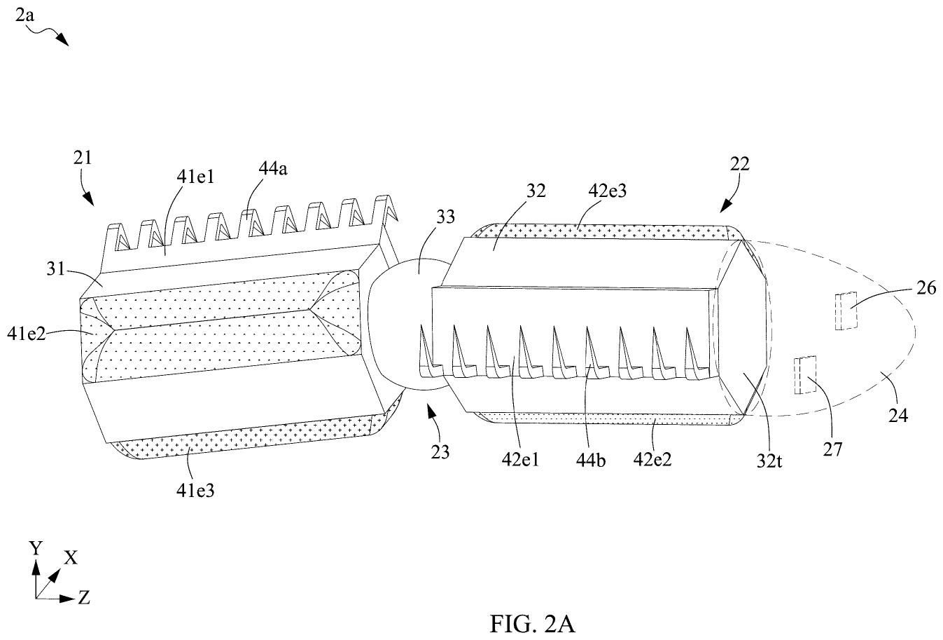

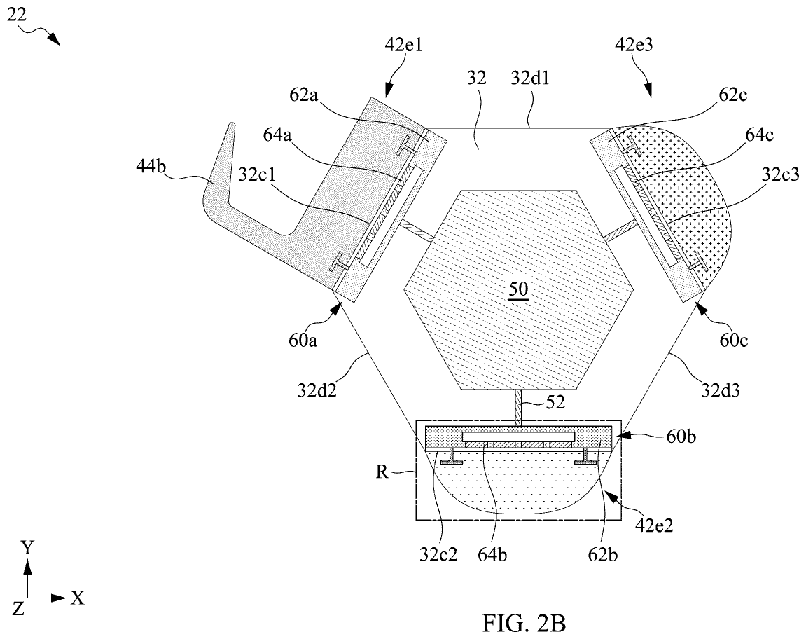

FIG. 2A illustrates a perspective view of an electronic device 2a, in accordance with some arrangements of the present disclosure. In some arrangements, each of the mechanical units 12, 13, 14, 15, and 16 may have a structure and function the same as or similar to those of the electronic device 2a. In some arrangements, the electronic device 2a may include a bionic structure and may be included in, for example, a robot.

In some arrangements, the electronic device 2a may include a phalange region 21 (or rotatable region), a phalange region 22 (or rotatable region), and a joint region 23. The phalange region 21 may be spaced apart from the phalange region 22 by the joint region 23. Each of the phalange regions 21 and 22 may be configured to mimic an abduction movement of a human phalange. The joint region 23 may be mechanically coupled to and disposed between the phalange regions 21 and 22. In some arrangements, the joint region 23 may be configured to control, adjust, and/or modify the relative positions (or relative motions) of the phalange regions 21 and 22. In some arrangements, each of the phalange regions 21 and 22 may be configured to move along the X-direction, Y-direction, and a combination thereof, dependently or independently. In some arrangements, each of the phalange regions 21 and 22 may be configured to contact, hold, or grasp an object. Although FIG. 2A illustrates that the electronic device 2a includes two phalange regions and one joint region, the electronic device 2a may include an additional phalange region and an additional joint region in order to mimic the abduction movement of a human finger. In this arrangement, the phalange region 21 may function as a proximal phalange region or an intermediate phalange region, and the phalange region 22 may function as a distal phalange region. For example, the distance between a palm unit (not shown) and the phalange region 22 may be greater than that between the palm unit and the phalange region 21.

In some arrangements, the electronic device 2a may include a sensing region 24. In some arrangements, the sensing region 24 may be disposed on the edge (e.g., on the side (e.g., a side 32t of a shell 32) of the distal phalange region) of the electronic device 2a. In some arrangements, the sensing region 24 may be configured to detect or identify a characteristic of an object. In some arrangements, the electronic device 2a may include a sensor 26 within the sensing region 24. In some arrangements, the sensor 26 may include an image sensor, which may be configured to capture an image signal (or image data) of an object. In some arrangements, the sensor 26 may include a proximity sensor (or distance sensor), which may be configured to detect a distance of an object. In some arrangements, the sensor 26 may include a temperature sensor, which may be configured to detect a temperature of an object. In some arrangements, the sensor 26 may include other sensors configured to detect or identify other characteristics of an object.

In some arrangements, the electronic device 2a may include a processor 27 within the sensing region 24. The processor 27 may be configured to process the signals from the sensor 26. For example, the processor 27 may be configured to process the signals from the image sensor, proximity sensor, temperature sensor, or other suitable sensors. As a result, the electronic device 2a may identify the characteristics of an object. For example, the shape, size, dimensions, weight, volume, pose, surface material, location, temperature, distance, or other characteristics of an object may be identified. Although FIG. 2A illustrates that the sensing region 24 is disposed on the edge of the phalange region 22, the sensing region 24 may be located on other regions of the electronic device 2a. For example, the sensing region 24 may be disposed on the palm unit or other regions of a robot not shown in FIG. 1 or FIG. 2A.

In some arrangements, the electronic device 2a may include shells 31 and 32 (or frameworks). The shell 31 may be disposed within the phalange region 21. The shell 32 may be disposed within the phalange region 22. Each of the shells 31 and 32 may provide contact surfaces configured to contact an object. Each of the shells 31 and 32 may be configured to accommodate the electrical interconnections (e.g., traces), sensors, rotatable module, or other components. The electronic device 2a may include a driver 33. In some arrangements, the driver 33 may be mechanically coupled to and disposed between the shells 31 and 32. In some arrangements, the driver 33 may be configured to control, adjust, and/or modify the relative positions (or relative motions) of the phalange regions 21 and 22. The driver 33 may include, for example, a motor. In some arrangements, the driver 33 may be configured to facilitate the movement and/or rotation of the phalange region 21 (or shell 31) and/or phalange region 22 (or shell 32). For example, the phalange region 21 (or shell 31) may rotate around the XZ plane, YZ plane, and a combination thereof with the driver 33 functioning as the axis of rotation. The phalange region 22 (or shell 32) may rotate around the XZ plane, YZ plane, and a combination thereof with the driver 33 functioning as the axis of rotation. In some arrangements, the driver 33 may be configured to rotate the phalange region 21 (or shell 31) along the Z-direction, thereby facilitating the rotation of the contact surfaces of the shell 31. In some arrangements, the driver 33 may be configured to rotate the phalange region 22 (or shell 32) along the Z-direction, thereby facilitating the rotation of the contact surfaces of the shell 32.

In some arrangements, the phalange region 21 may include end effectors 41e1, 41e2, and 41e3. Each of the end effectors 41e1, 41e2, and 41e3 may be configured to contact, hold, and/or grasp an object. In some arrangements, the end effectors 41e1, 41e2, and 41e3 may include different materials (or contact materials), such as a heat resistant material, wear resistant material, and other suitable materials. For example, the end effector 41e1 may function as a load-bearable end effector, which may be configured to contact, hold, and/or grasp an object with a relatively great weight. In some arrangements, the end effector 41e1 may include at least one load-bearable element 44a, which may be configured to contact, catch, hook, and/or hold an object. In some arrangements, the load-bearable element 44a (or holder) may include a hook, which may have a curved profile. The end effector 41e1 may include metallic material (e.g., stainless steel), plastic material (e.g., resin), or other suitable materials. In some arrangements, the end effector 41e2 may function as a wear resistant end effector, which may be configured to contact, hold, and/or grasp an object with a relatively great rough surface. The end effector 41e2 may include rubber, fiber, or other suitable materials. The end effector 41e2 may include liquid silicone rubber (LSR), carbon fiber, or other suitable materials. In some arrangements, the end effector 41e3 may function as a heat resistant end effector, which may be configured to contact, hold, and/or grasp an object with a relatively great temperature. The end effector 41e3 may include organic material, inorganic material with or without fillers (or additives). The end effector 41e3 may include polyphenylene sulfide, ceramic, or other suitable materials.

In some arrangements, the phalange region 22 may include end effectors 42e1, 42e2, and 42e3 (or bodies). Each of the end effectors 42e1, 42e2, and 42e3 may be configured to contact, hold, and/or grasp an object. In some arrangements, the end effectors 42e1, 42e2, and 42e3 may include different materials (or contact materials), such as a heat resistant material, wear resistant material, and other suitable materials. For example, the end effector 42e1 may function as a load-bearable end effector, which may be configured to contact, hold, and/or grasp an object with a relatively great weight. In some arrangements, the end effector 42e1 may include at least one load-bearable element 44b (or holder), which may be configured to contact, catch, hook, and/or hold an object. In some arrangements, the load-bearable element 44b may include a hook, which may have a curved profile. The end effector 42e1 may include metallic material (e.g., stainless steel), plastic material (e.g., resin), or other suitable materials. In some arrangements, the end effector 42e2 may function as a wear resistant end effector, which may be configured to contact, hold, and/or grasp an object with a relatively great rough surface. The end effector 42e2 may include rubber, fiber, or other suitable materials. The end effector 42e2 may include liquid silicone rubber, carbon Fiber, or other suitable materials. In some arrangements, the end effector 42e3 may function as a heat resistant end effector, which may be configured to contact, hold, and/or grasp an object with a relatively great temperature. The end effector 42e3 may include organic material, inorganic material with or without fillers (or additives). The end effector 42e3 polyphenylene sulfide, ceramic, or other suitable materials.

In some arrangements, each of the end effectors 41e1, 41e2, and 41e3 may be configured to be detachable from the shell 31. Therefore, the end effectors 41e1, 41e2, and 41e3 may be replaced with new ones, thereby extending the lifespan of the electronic device 2a. In some arrangements, each of the end effectors 42e1, 42e2, and 42e3 may be configured to be detachable from the shell 32. Therefore, each of the end effectors 42e1, 42e2, and 42e3 may be replaced with new ones, thereby extending the lifespan of the electronic device 2a.

In some arrangements, the sensing region 24 may be configured to detect and/or identify the characteristics (e.g., size, weight, temperature, surface material, and the like) of an object, and generate and/or transmit processed signals. The end effectors of each phalange region of each mechanical unit may be selected independently to contact, hold, and/or grasp an object. For example, in some cases, the end effector 41e1 of the phalange region 21 may be selected, and the end effector 42e2 of the phalange region 22 may be selected to contact, hold, and/or grasp an object. For example, in some cases, the load-bearable end effector of the distal phalange of the thumb unit is selected, and the heat resistant end effector of the distal phalange of the index unit of an electronic device (e.g., electronic device 1) is selected to contact, hold, and/or grasp an object.

FIG. 2B illustrates a cross-sectional view of the phalange region 22, in accordance with some arrangements of the present disclosure. It should be noted that the phalange region 21 or other phalange regions can have a structure the same as or similar to that of the phalange region 22.

As shown in FIG. 2B, the shell 32 may include contact surfaces 32c1, 32c2, and 32c3 (or regions). In some arrangements, the contact surfaces 32c1, 32c2, and 32c3 may be configured to contact an object. The end effector 42e1 may be disposed on and cover the contact surface 32c1. The end effector 42e2 may be disposed on and cover the contact surface 32c2. The end effector 42e3 may be disposed on and cover the contact surface 32c3. In some arrangements, the shell 32 may include dummy surfaces 32d1, 32d2, and 32d3. The dummy surfaces 32d1, 32d2, and 32d3 may be configured to separate the contact surfaces 32c1, 32c2, and 32c3 from each other. In other arrangements, the dummy surfaces 32d1, 32d2, and 32d3 may also function as contact surfaces configured to contact, hold, and/or grasp an object. In some arrangements, the dummy surfaces 32d1, 32d2, and 32d3 of the shell 32 may be exposed to the external environment. Although FIG. 2B illustrates that the shell 32 has six surfaces or has a hexagonal profile, the shell 32 can have other profiles in other arrangements.

In some arrangements, the electronic device 2a may include a rotatable module 50. The rotatable module 50 may be disposed within the phalange region 22. The rotatable module 50 may be disposed within the shell 32. The rotatable module 50 may be rotatable, thereby rotating the shell 32 (or phalange region 22). In some arrangements, the rotatable module 50 may be configured to select one of the contact surfaces or end effectors to contact, hold, and/or grasp an object. In some arrangements, the rotatable module 50 may be configured to be rotated around the Z-direction by a driver (e.g., the driver 33 or other drivers). Although FIG. 2B illustrates that the rotatable module 50 has six surfaces or has a hexagonal profile, the rotatable module 50 can have other profiles in other arrangements. In some arrangements, the rotatable module 50 may be electrically coupled and mechanically coupled to the sensing region 24. The sensing region 24 may be configured to determine which contact surfaces or end effectors is selected, and thus to rotate the rotatable module 50.

In some arrangements, the electronic device 2a may include packages 60a, 60b, and 60c (or sensing modules). Each of the packages 60a, 60b, and 60c may be electrically coupled to the rotatable module 50 by circuits 52. In some arrangements, the circuits 52 may be configured to transmit signals (e.g., sensing signals) from the sensors within the packages 60a, 60b, and 60c to the rotatable module 50 or to processors (not shown in FIG. 2B). The circuits 52 may be disposed within the shell 32.

The package 60a may abut the contact surface 32c1 of the shell 32. The package 60a may be disposed between the end effector 42e1 and the shell 32. The package 60a may include a carrier 62a and sensors 64a. The carrier 62a may include a circuit structure (e.g., printed circuit board or other components) and electrical interconnections configured to electrically connect the sensors 64a. In some arrangements, the sensors 64a may be configured to generate and/or transmit signals in response to the stress (or pressure) generated by an object, thereby adjusting the relative position between the end effector 42e1 and the object. In some arrangements, the sensors 64a may include capacitive sensors, piezoelectric sensors, or other suitable sensors. In some arrangements, the sensors 64a may be configured to generate and/or transmit signals in response to a distance between the end effector 42e1 and an object. In some arrangements, the sensors 64a may include proximity sensors (or distance sensors).

The package 60b may abut the contact surface 32c2 of the shell 32. The package 60b may be disposed between the end effector 42e2 and the shell 32. The package 60b may include a carrier 62b and sensors 64b. The carrier 62b may include a circuit structure (e.g., printed circuit board or other components) and electrical interconnections configured to electrically connect the sensors 64b. In some arrangements, the sensors 64b may be configured to generate and/or transmit signals in response to the stress (or pressure) generated by an object, thereby adjusting the relative position between the end effector 42e2 and the object. In some arrangements, the sensors 64b may include capacitive sensors, piezoelectric sensors, or other suitable sensors. In some arrangements, the sensors 64b may be configured to generate and/or transmit signals in response to a distance between the end effector 42e2 and an object. In some arrangements, the sensors 64b may include proximity sensors (or distance sensors).

The package 60c may abut the contact surface 32c3 of the shell 32. The package 60c may be disposed between the end effector 42e3 and the shell 32. The package 60c may include a carrier 62c and sensors 64c. The carrier 62c may include a circuit structure (e.g., printed circuit board or other components) and electrical interconnections configured to electrically connect the sensors 64c. In some arrangements, the sensors 64c may be configured to generate and/or transmit signals in response to the stress (or pressure) generated by an object, thereby adjusting the relative position between the end effector 42e3 and the object. In some arrangements, the sensors 64c may include capacitive sensors, piezoelectric sensors, or other suitable sensors. In some arrangements, the sensors 64c may be configured to generate and/or transmit signals in response to a distance between the end effector 42e3 and an object. In some arrangements, the sensors 64c may include proximity sensors (or distance sensors).

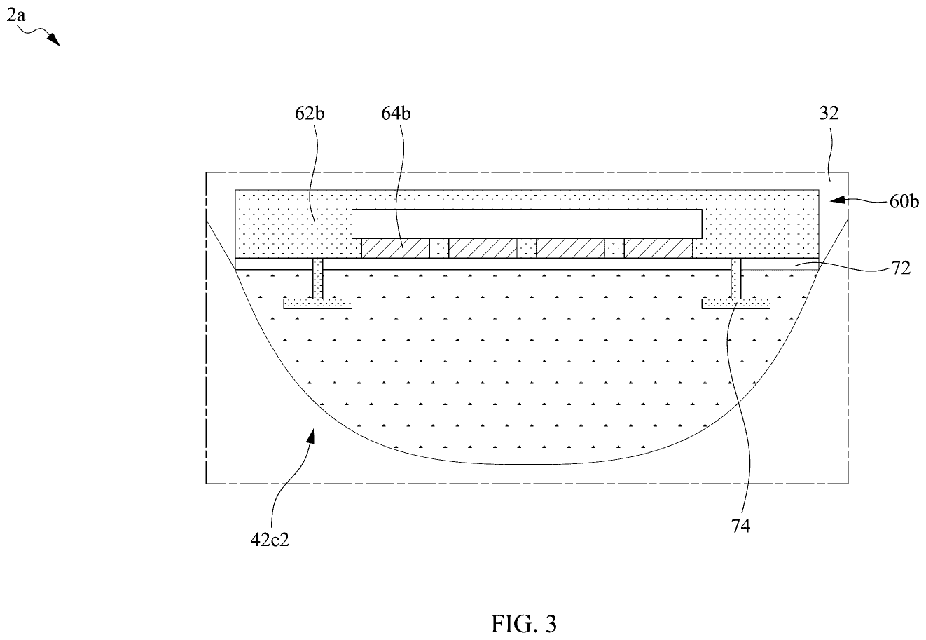

FIG. 3 is a partial enlarged view of the region R as shown in FIG. 2B, in accordance with some arrangements of the present disclosure.

In some arrangements, the electronic device 2a may include an adhesive 72. The adhesive 72 may be disposed between the end effector 42e2 and the package 60b (or between the end effector 42e1 and package 60a, or between the end effector 42e3 and package 60c). The adhesive 72 may be configured to attach the end effector 42e2 to the shell 32, thereby preventing the delamination of the end effector 42e2.

In some arrangements, the electronic device 2a may include at least one fixing element 74 (or fastener). In some arrangements, the fixing element 74 may be configured to fix the end effector 42e2 (or end effector 42e1 or 42e3) to the shell 32 or to the package 60b (or package 60a and 60c). In some arrangements, the fixing element 74 may be inserted into the material of the end effector 42e2 (or end effector 42e1 or 42e3). In some arrangements, the fixing element 74 may extend from the package 60b to the end effector 42e2. In some arrangements, the fixing element 74 may be stretchable, allowing for the replacement of the end effector 42e2 (as well as end effectors 42e1 or 42e3). In some arrangements, each of the end effector 42e2 (or end effector 42e1 or 42e3) may be configured to be detachable from the fixing element 74. In some arrangements, each of the end effector 42e2 (or end effector 42e1 or 42e3) may be configured to be detachable from the package 60b (or package 60a and 60c).

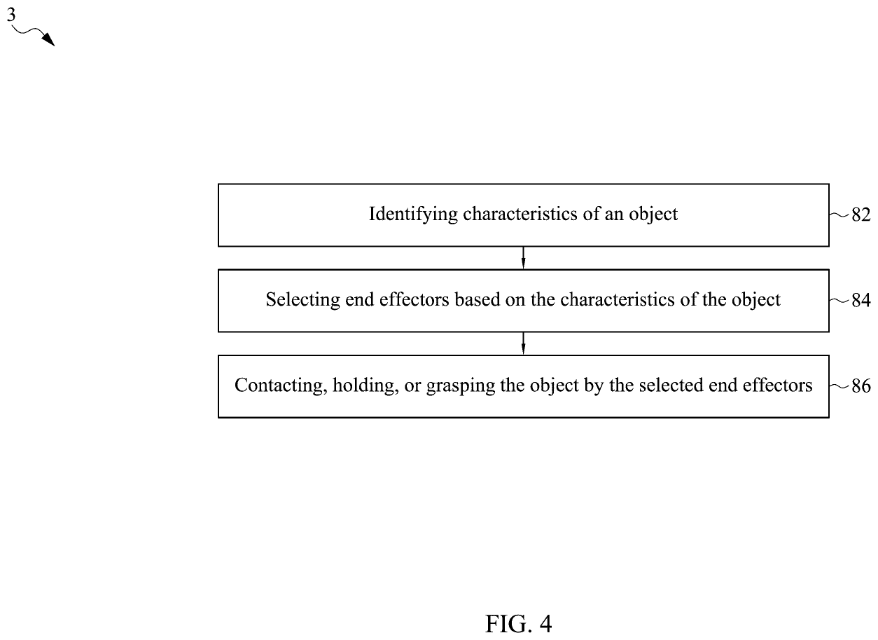

FIG. 4 is a flowchart illustrating the method 3 of operations of an electronic device, in accordance with some arrangements of the present disclosure.

The method 3 may begin with an operation 82 in which an electronic device (e.g., a bionic structure) identifies characteristics of an object (or external object). For example, the electronic device may catch the image signal (or data) of an object. For example, the electronic device may detect a distance between the electronic device and an object. For example, the electronic device may detect a temperature of an object.

The method 3 may continue with an operation 84 in which end effectors of the electronic device are selected based on the characteristics of the object.

The method 3 may continue with an operation 86 in which the electronic device contacts, holds, or grasps the object by the selected end effectors.

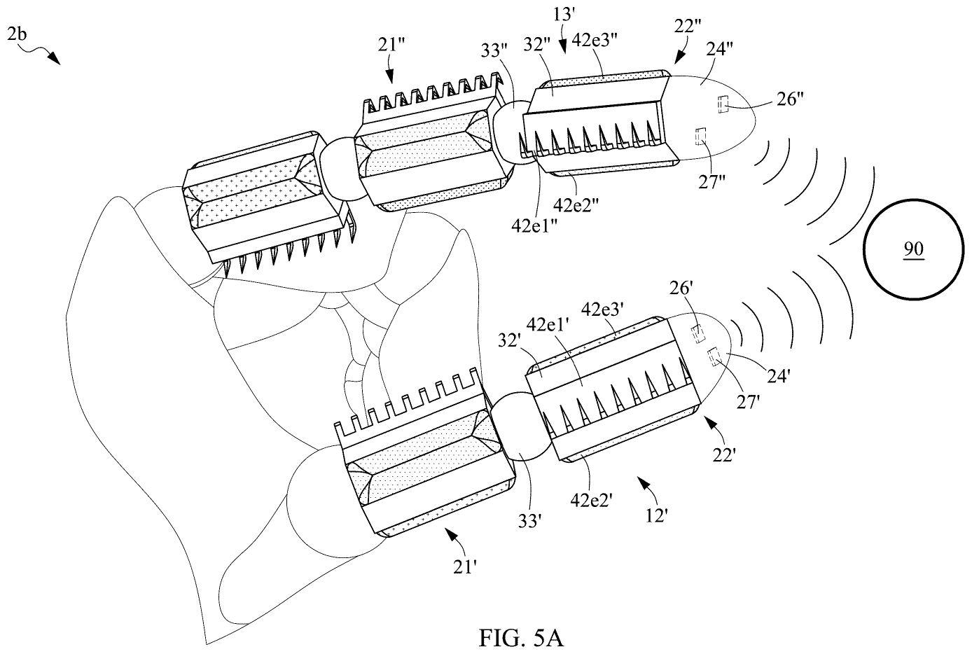

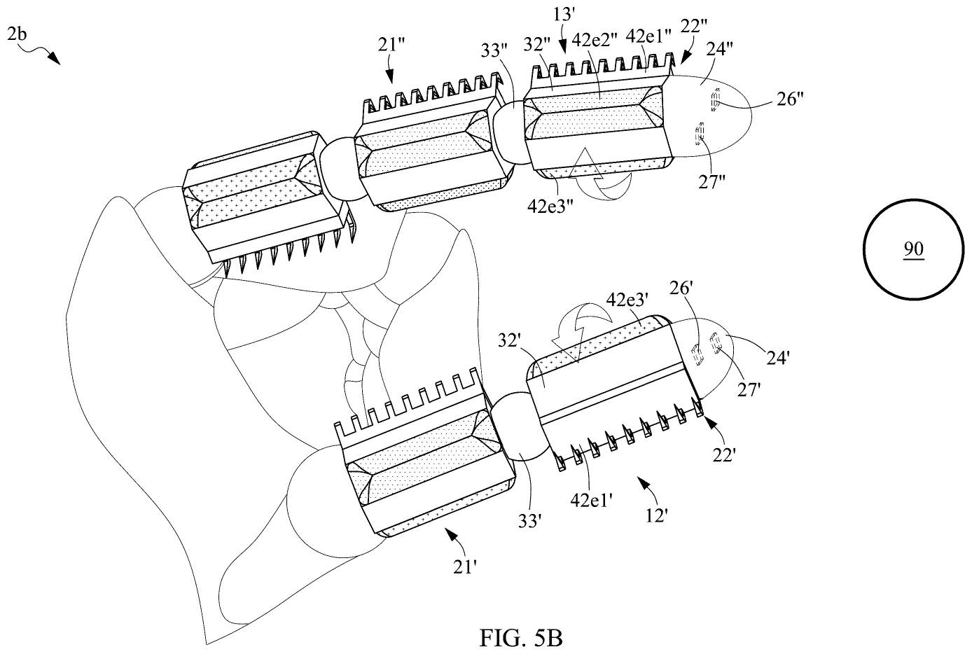

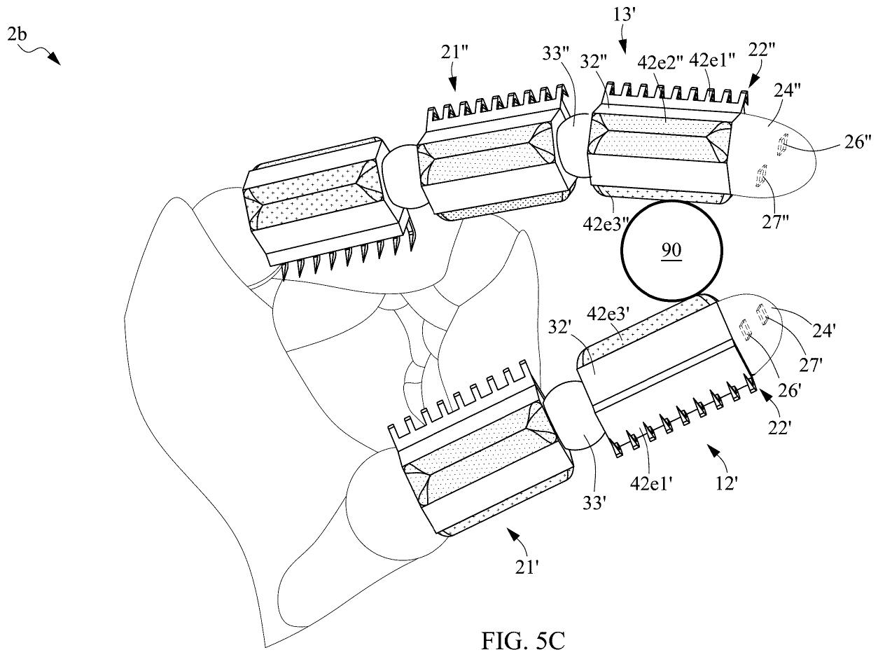

FIG. 5A, FIG. 5B, and FIG. 5C illustrate stages of an example of operations of an electronic device 2b according to some embodiments of the present disclosure.

Referring to FIG. 5A, an electronic device 2b may be provided. The electronic device 2b may include a mechanical unit 12′ and a mechanical unit 13′. The mechanical unit 12′ may include a phalange region 21′ and a phalange region 22′ configured to contact, hold, and/or grasp an object 90. The mechanical unit 13′ may include a phalange region 21″ and a phalange region 22″ configured to contact, hold, and/or grasp the object 90. The electronic device 2b may include a sensing region 24′ on a shell 32′. The electronic device 2b may include a sensing region 24″ on a shell 32″. The sensing region 24′ may include a sensor 26′ and a processor 27′ configured to identify the characteristics of the object 90. The sensing region 24″ may include a sensor 26″ and a processor 27″ configured to identify the characteristics of the object 90. Each of the phalange regions 21′ and 22′ may be moved and rotated by a driver 33′. Each of the phalange regions 21″ and 22″ may be moved and rotated by a driver 33″. The mechanical unit 12′ may include end effectors 42e1′, 42e2′, and 42e3′ on the shell 32′. The mechanical unit 13′ may include end effectors 42e1″, 42e2″, and 42e3″ on the shell 32″. In some arrangements, at least one of the mechanical units 12′ and 13′ may be configured to identify the characteristics of the object 90. In this arrangements, the sensing regions 24′ and 24″ may generate processed signals (or sensing signals or processed sensing signals) in response to the characteristics of the object 90.

Referring to FIG. 5B, the phalange regions of the mechanical units may be selected to contact, hold, and/or grasp the object 90, in response to the processed signals, based on the characteristics of the object 90. In some cases, the phalange region 22′ of the mechanical unit 12′ and the phalange region 22″ of the mechanical unit 13′ are selected. The shell 32′ of the phalange region 22′ of the mechanical unit 12′ may be rotated to enable the selected end effector to make contact with the object 90. The shell 32″ of the phalange region 22″ of the mechanical unit 13′ may be rotated to enable the selected end effector to make contact with the object 90.

Referring to FIG. 5C, the selected end effectors of the mechanical units may approach, make contact with, hold, and/or grasp the object 90. In some cases, the object 90 may be identified and exhibit a relatively high temperature. Thus, the end effectors 42e3′ and 42e3″ may be selected. The electronic device 2b may contact, hold, and/or grasp the object 90 through the end effectors 42e3′ and 42e3″.

As used herein, the singular terms “a,” “an,” and “the” may include a plurality of referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same or equal if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” parallel can refer to a range of angular variation relative to 0° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a sensor configured to detect an object and to generate a sensing signal; and
a bionic structure comprising a plurality of end effectors,
wherein the plurality of end effectors are configured to be selected to contact the object in response to the sensing signal.

2. The electronic device of claim 1, wherein the plurality of end effectors comprises different materials.

3. The electronic device of claim 1, wherein the plurality of end effectors are spaced from each other.

4. The electronic device of claim 1, wherein the sensor is configured to capture image data of the object.

5. The electronic device of claim 1, wherein the plurality of end effectors comprise a heat resistant end effector, a wear resistant end effector, and a load-bearable end effector.

6. The electronic device of claim 1, wherein the bionic structure comprises mechanical fingers on which the plurality of end effectors are disposed.

7. The electronic device of claim 6, wherein the mechanical fingers are configured to be rotatable to select one of the plurality of end effectors to contact the object.

8. The electronic device of claim 6, wherein one of the mechanical fingers comprises a first phalange region and a second phalange region separated from the first phalange region, and the plurality of end effectors are disposed on the first phalange region and the second phalange region.

9. The electronic device of claim 8, wherein the first phalange region and the second phalange region are configured to be rotatable to select a first end effector and a second end effector of different materials to contact the object.

10. The electronic device of claim 6, wherein a first end effector of a first one of the mechanical fingers and a second end effector of a second one of the mechanical fingers are configured to be selected to contact the object and have different materials.

11. An electronic device, comprising:
a bionic structure comprising a plurality of regions configure to operate with different functions; and
a first sensor configured to identify characteristics of an object,
wherein the plurality of regions are selectable to contact the object based on the characteristics of the object.

12. The electronic device of claim 11, wherein the bionic structure comprises a rotatable module configured to rotate the plurality of regions.

13. The electronic device of claim 11, wherein the bionic structure comprises a fastener, and one of the plurality of regions comprises a body which is detachable from the fastener.

14. The electronic device of claim 13, wherein the bionic structure comprises a package abutting the body, and the fastener extends from the package to the body.

15. The electronic device of claim 14, wherein the package comprises a second sensor configured to detect a distance between the one of the plurality of regions and the object.

16. The electronic device of claim 14, wherein the package comprises a second sensor configured to detect a stress imposed on the one of the plurality of regions.

17. An electronic device, comprising:
a first phalange region and a second phalange region separated from the first phalange region,
wherein the first phalange region comprises a plurality of sensing modules and a first plurality of portions detachable from the sensing modules, respectively.

18. The electronic device of claim 17, wherein the second phalange region comprises a second plurality of portions separated from the first plurality of portions and configured to contact an object.

19. The electronic device of claim 18, wherein the first plurality of portions and the second plurality of portions are configured to be rotatable independently.

20. The electronic device of claim 17, further comprising:
a driver configured to mechanically move the first phalange region with respect to the second phalange region.
